(19) United States
(12) Patent Application Publication
(10) Pub. No.: US 2011/0317025 A1
(43) Pub. Date: Dec. 29, 2011

(54) DVD camcorder with digital camera

(76) Inventor: Emmanuel Anyika, Cary, NC (US)

(21) Appl. No.: 13/134,910

(22) Filed: Jun. 20, 2011

Related U.S. Application Data
(60) Provisional application No. 61/398,432, filed on Jun. 25, 2010.

(51) Int. Cl. H04N 5/225

(52) U.S. Cl. 348/220.1

(57) ABSTRACT

DVD Camcorder with Digital Camera is a specially designed video camera that records images in a digital format and is replayed on a standard DVD player. The DVD Camcorder with Digital Camera also features a fully functioning digital camera with which the user records still images. The D.V.D Camcorder with Digital Camera is extremely compact in size and could be comfortably held in a hand. In an embodiment this device is configured to burn images directly onto a digital video disc. The device facilitates playback on a TV as well as real-time monitoring of what is being recorded.

### CLAIM OF PRIORITY

This patent application claims priority under 35 USC 119 (e)(1) from U.S. Provisional Patent Application Ser. No. 61/398,432 filed Jun. 25, 2010, of common inventorship herewith entitled, “DVD Camcorder with Digital Camera.”

### FIELD OF THE INVENTION

The present invention pertains to the field of digital recording devices, and more specifically to the field of digital camera recording and playback devices.

### BACKGROUND OF THE INVENTION

The prior art has put forth several designs for digital camera recording and playback devices. Among these are:

U.S. Pat. No. 3,792,486 to Karl-Heinz Lange and Hermann Korher describes a camera radio combination. The combination has a conventional camera provided with a camera housing having in its interior spaces which normally would remain empty. A radio receiver has components situated in these spaces.

U.S. Pat. No. 7,106,954 to Hisashi Inoue, et al. describes a digital image and speech recording and reproducing apparatus is arranged to quickly and simply retrieve, classify, and erase a great deal of data for improving the operativity in small-sized equipment.

U.S. Pat. No. 7,283,730 to Naoki Inoue describes an optical disc camcorder unit with a base plate assembly attached to the main body via a rotating shaft whose rotating ability provides improved recording and reproduction characteristic and tracking performance.

None of these prior art references describe the present invention.

### SUMMARY OF THE INVENTION

It is an object of the present invention to provide a digital camera recording and playback device.

### BRIEF DESCRIPTION OF THE DRAWINGS

FIG. 1 is an elevational angled perspective view of the device of the present invention.

FIG. 2 is a close-up elevational angled perspective view of a portion of the device of the present invention.

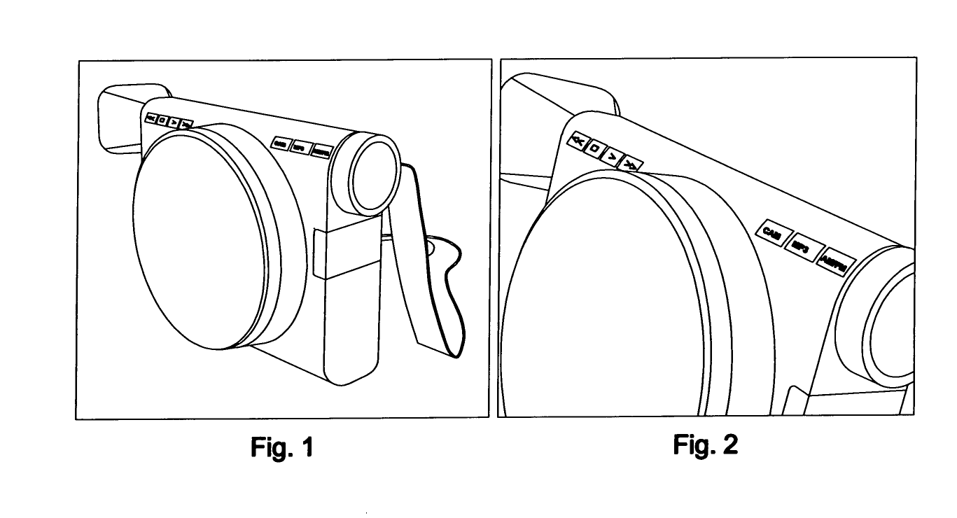

### DETAILED DESCRIPTION OF THE INVENTION

The present invention, hereinafter referred as the DVD Camcorder with Digital Camera is a specially designed video camera that records images in a digital format and is replayed on a standard DVD player. The DVD Camcorder with Digital Camera also features a fully functioning digital camera with which the user records still images. The D.V.D Camcorder with Digital Camera is extremely compact in size and could be comfortably held in a hand.

A durable leather carrying strap is included and secured to each end of the device for use in safely and comfortably transporting the device. This product features the standard components of a camcorder device, with a lens, adjustable zoom capability, lens pan capability, operational buttons, record, play, stop, rewind, forward, and pause, and of course, a digital recording chip. Additionally, the DVD Camcorder with Digital Camera comes equipped with audio/video output/input connectors that joins the device with any television set or computer system. As mentioned, the DVD Camcorder component of the device records digital video and sound on a recordable chip. In another embodiment this device is configured to burn images directly onto a digital video disc. As such, the product facilitates playback on a TV as well as real-time monitoring of what is being recorded. The Digital Camera portion of the DVD Camcorder with Digital Camera functions in a similar manner as traditional digital cameras and are programmed to take still photographs or limited video images digitally by recording the images on a light sensitive sensor. Other design features include an LCD display screen for instant playback, as well as the capacity to take thousands of images on a single small memory device, the ability to edit and delete images, and re-use of the storage they occupied. The DVD Camcorder with Digital Camera boasts a built-in AM/FM radio, as well as an integrated MP3 player.

Fully developed, the DVD Camcorder with Digital Camera replaces the outdated and irrelevant video camcorders which record images on tape. Allowing for instant enjoyment of recorded images, this multi-media device is utilized to record any number of videos and photographs, providing household consumers, professional photographers and videographers alike a simple means of capturing memories digitally.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A digital camera recording and playback device, comprising a DVD camcorder with digital camera that records images in a digital format and is replayed on a standard DVD player wherein the DVD camcorder with digital camera further comprises a fully functioning digital camera with which the user records still images.

2. The device of claim 1 further comprising a durable leather carrying strap is included and secured to each end of the device for use in safely and comfortably transporting the device.

3. The device of claim 1 further comprising a lens, adjustable zoom capability, lens pan capability, operational buttons, record, play, stop, rewind, forward, and pause, and of course, a digital recording chip.

4. The device of claim 3 further comprising audio, video output and input connectors that joins the device with any television set or computer system.

5. The device of claim 4 wherein the DVD camcorder component of the device records digital video and sound on a recordable chip.

6. The device of claim 4 wherein the device is configured to burn images directly onto a digital video disc.

7. The device of claim 3 further comprising an LCD display screen for instant playback, and the ability to edit and delete images, and re-use of the storage they occupied.

8. The device of claim 3 further comprising an AM/FM radio, and an MP3 player.
